(19) United States
(12) Patent Application Publication
(10) Pub. No.: US 2005/0276506 A1
(43) Pub. Date: Dec. 15, 2005

(54) Apparatus and method to remove jagging artifact

(76) Inventors: Young-jin Kwon, Seoul (KR); Seung-joon Yang, Seoul (KR)

Correspondence Address: STANZIONE & KIM, LLP, 919 18TH STREET, N.W., SUITE 440, WASHINGTON, DC, 20006, US

(21) Appl. No.: 11/117,420

(22) Filed: Apr. 29, 2005

(30) Foreign Application Priority Data
Jun. 9, 2004 (KR) 2004-42168

(51) Int. Cl. G06K 9/00; G06K 9/40

(52) U.S. Cl. 382/269; 382/264

(57) ABSTRACT

In an apparatus and a method to remove jagging artifacts, a calculating unit defines a window of a predetermined size based on a current pixel in an input current frame or field, and calculates at least one eigen value and at least one eigen vector to determine a feature of the window. A weight determining unit determines the feature of the window based on the calculated eigen value and then determines a filtering weight to be applied to filtering based on the determined feature. A low pass filter filters the window based on the calculated eigen vector and the determined filtering weight. Accordingly, it is possible to remove jagging artifacts occurring in a region, such as an edge, upon image conversion.

### CROSS-REFERENCE TO RELATED APPLICATIONS

This application claims the priority under 35 U.S.C. § 119 of Korean Patent Application No. 2004-42168, filed on Jun. 9, 2004, in the Korean Intellectual Property Office, the disclosure of which is incorporated herein in its entirety by reference.

### BACKGROUND OF THE INVENTION

1. Field of the Invention

The present general inventive concept relates to an apparatus and a method to remove jagging artifacts, and more particularly, to an apparatus and a method to remove jagging artifacts, such as staircasing, occurring upon image conversion.

2. Description of the Related Art

Jagging artifacts, as shown in FIG. 1, are a phenomenon in which each diagonal line of an image is not viewed as a line but as a stair, which deteriorates image quality. The staircasing occurs due to de-interlacing, scaling, or the like, and is variously called staircasing, diagonal noise, or the like.

Meanwhile, a conventional image quality processing apparatus for removing sawtooth artifacts that are a type of jagging artifact is disclosed in U.S. Pat. No. 5,625,421, which is shown in FIG. 2.

Referring to FIG. 2, a conventional image quality processing apparatus includes a detecting unit 210 and a vertical filter 220. The detecting unit 210 detects a region in an input image signal (in) where sawtooth artifacts occur. That is, if there is a difference greater than a first threshold value between a deinterlaced scan line and two adjacent horizontal scan lines and less than a second threshold value between the deinterlaced scan line and next scan lines of the adjacent horizontal scan lines, the detecting unit 210 determines that the sawtooth artifacts have occurred in a region where the deinterlaced scan line is positioned.

The vertical filter 220 vertically filters the region determined to be the region where the sawtooth artifacts have occurred, and outputs an output image signal (out). This is intended to remove the staircasing by blurring the region where the jagging artifacts have occurred.

However, the conventional image quality processing apparatus uses the threshold values to determine the region where the jagging artifacts have occurred. For this reason, the apparatus may fail to discover the region where the sawtooth artifacts have occurred or may erroneously make a determination. Moreover, the performance of the vertical filtering on the region where the jagging artifacts have occurred does not clearly remove the jagging artifacts, thus deteriorating the image quality.

### SUMMARY OF THE INVENTION

The present general inventive concept provides an apparatus and a method to remove jagging artifacts that occur in a region, such as an edge of an image, in an image conversion process.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an apparatus to remove jagging artifacts, including a calculating unit to set up a window of a predetermined size based on a current pixel in an input current frame or field, and to calculate at least one eigen value and at least one eigen vector to determine a feature of the window, a weight determining unit to determine the feature of the window based on the calculated eigen value and to determine a filtering weight based on the determined feature, and a low pass filter to filter the window based on the calculated eigen vector and the determined filtering weight.

The at least one eigen vector may include a first eigen vector to indicate a gradient direction of the window and a second eigen vector to indicate an edge direction thereof, and the at least one eigen value may include a first eigen value to indicate dispersion in the gradient direction and a second eigen value to indicate dispersion in the edge direction.

The calculating unit may include a matrix calculating unit to apply principal component analysis (PCA) to the window to calculate a covariance matrix, an eigen value calculating unit to calculate the first and second eigen values based on the covariance matrix, and an eigen vector calculating unit to calculate the first and second eigen vectors based on the covariance matrix.

The weight determining unit may include a feature determining unit to compare a size of the first eigen value to a size of the second eigen value to determine the feature of the window, and a weight calculating unit to calculate the filtering weight used by the low pass filter to filter the window based on the determined feature.

The feature determining unit may determine that the window is a corner region when a ratio of the first eigen value to the second eigen value is less than or equal to a first threshold value, and that the window is an edge region when the ratio is greater than or equal to a second threshold value.

The weight calculating unit may calculate the weight of ‘0’ when it is determined that the window is the corner region, and the weight of ‘1’ when it is determined that the window is the edge region.

The low pass filter may include a pixel average calculating unit to confirm positions of a previous pixel and a next pixel in the window and an edge direction of the window based on at least one of the first and second eigen vectors output from the eigen vector calculating unit and a position of the current pixel, and to calculate an average value of the previous pixel and the next pixel, and a filtering unit to filter the window in the confirmed edge direction using the calculated average value, a value of the current pixel, and the determined filtering weight to output a final pixel value of the current pixel.

The eigen vector calculating unit may output a smaller one of the first and second eigen vectors as a minimum eigen vector to the low pass filter.

The foregoing and/or other aspects of the present general inventive concept are also achieved by providing a method of removing jagging artifacts, the method including setting up a window of a predetermined size based on a current pixel in an input current frame or field, calculating at least one eigen value and at least one eigen vector to determine a feature of the window, determining the feature of the window based on the calculated eigen value and determining a filtering weight based on the determined feature, and filtering the window based on the calculated eigen vector and the determined filtering weight.

The calculating of the eigen value and the eigen vector may include applying principal component analysis (PCA) to the window to calculate a covariance matrix, calculating first and second eigen values based on the covariance matrix, and calculating first and second eigen vectors based on the covariance matrix.

The, determining of the feature of the window and the filtering weight may include comparing a size of the first eigen value to a size of the second eigen value to determine the feature of the window, and calculating the filtering weight to be applied to the filtering of the window based on the determined feature.

The determining of the feature of the window may include determining that the window is a corner region when a ratio of the first eigen value to the second eigen value is less than or equal to a first threshold value, and determining that the window is an edge region when the ratio is greater than or equal to a second threshold value.

The calculating of the filtering weight may include calculating the weight of ‘0’ when it is determined that the window is the corner region, and calculating the weight of ‘1’ when it is determined that the window is the edge region.

The filtering of the window may include confirming positions of a previous pixel and a next pixel in the window and an edge direction of the window based on at least one of the first and second calculated eigen vectors and a position of the current pixel and calculating an average value of the previous pixel and the next pixel, and filtering the window in the confirmed edge direction using the calculated average value, a value of the current pixel, and the determined filtering weight to output a final pixel value of the current pixel.

The calculating of the first and second eigen vectors may include outputting a smaller one of the first and second eigen vectors as a minimum eigen vector.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates an image having jagging artifacts;

FIG. 2 is a schematic block diagram of a conventional image quality processing apparatus;

FIG. 3 illustrates a schematic block diagram of an apparatus to remove jagging artifacts according to an embodiment of the present general inventive concept;

FIG. 4 illustrates a first eigen vector and a second eigen vector calculated by an eigen vector calculating unit of the apparatus of FIG. 3;

FIG. 5 illustrates a filtering weight calculated by a weight calculating unit of the apparatus of FIG. 3;

FIG. 6 illustrates a method of calculating an average value of pixel values in a pixel average calculating unit of the apparatus of FIG. 3;

FIG. 7 schematically illustrates a method of removing jagging artifacts in the apparatus of FIG. 3;

FIGS. 8A and 8B schematically illustrate an image quality processing system according an embodiment of the present general inventive concept including the apparatus to remove jagging artifacts of FIG. 3; and

FIG. 9 illustrates an image having no jagging artifacts.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

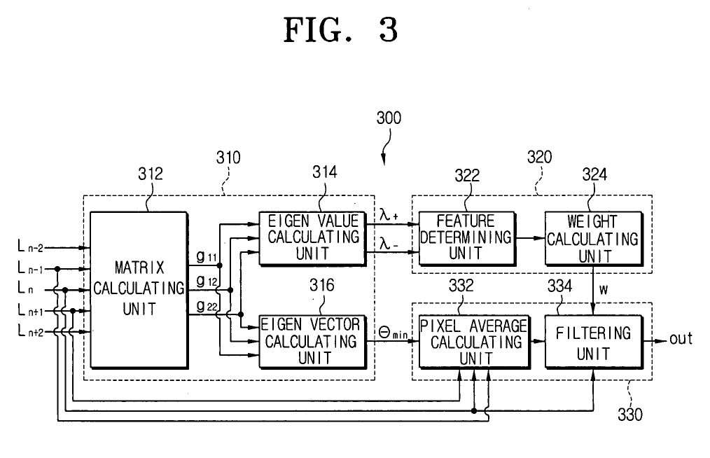

FIG. 3 illustrates a schematic block diagram of an apparatus to remove jagging artifacts according to an embodiment of the present general inventive concept. Referring to FIG. 3, the jagging artifact removing apparatus 300 includes a calculating unit 310, a weight determining unit 320, and a low pass filter 330.

The calculating unit 310 defines a window of a predetermined size based on a current pixel in an input current frame or field, and calculates at least one eigen value and at least one eigen vector to determine a feature of the window based on pixel values in the window. As illustrated in FIG. 3, the window includes at least a previous scan line Lₙ₋₁, a current scan line Lₙ and a next scan line Lₙ₊₁.

The calculating unit 310 calculates the at least one eigen value and the at least one eigen vector through the application of principal component analysis (PCA). In the PCA, a covariance matrix of the defined window is obtained, and the at least one eigen value and the at least one eigen vector are calculated based on the covariance matrix. The at least one eigen value and the at least one eigen vector are used to determine an image pattern, namely, an image feature, of the window.

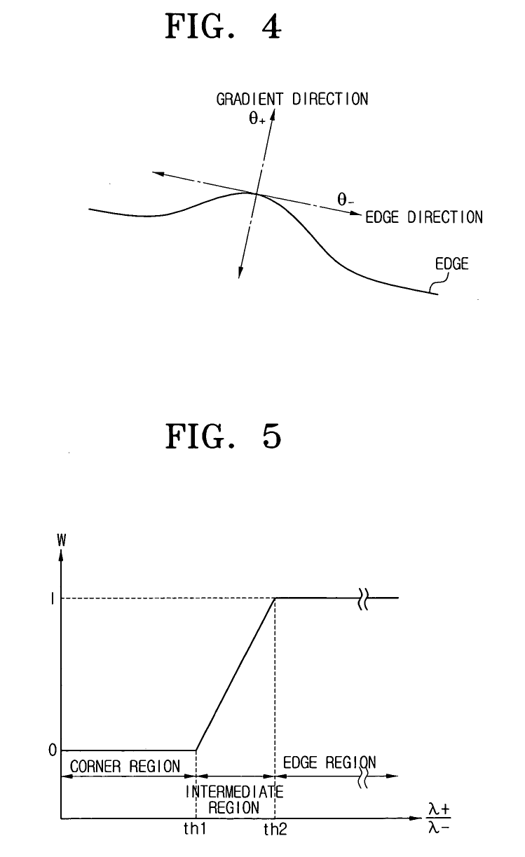

The at least one eigen vector can include a first eigen vector θ₊ and a second eigen vector θ₋, as illustrated in FIG. 4. Referring to FIG. 4, the first eigen vector θ₊ indicates a gradient direction of the window, and the second eigen vector θ₋ indicates an edge direction thereof.

Further, the at least one eigen value can include a first eigen value λ₊ to include dispersion in the gradient direction of the window and a second eigen value λ₋ to indicate dispersion in the edge direction.

The calculating unit 310 includes a matrix calculating unit 312, an eigen value calculating unit 314, and an eigen vector calculating unit 316.

The matrix calculating unit 312 defines the window and then applies the PCA to the defined window to calculate the covariance matrix according to Equation 1 below.

$$G = ( \begin{matrix}{g}_{11} & {g}_{12} \\ {g}_{12} & {g}_{22}\end{matrix} ) \\ ( {g}_{11} = {\sum }_{k = 1}^{n} {I}_{kx}^{2} , {g}_{12} = {\sum }_{k = 1}^{n} {I}_{kx} {I}_{ky} and {g}_{22} = {\sum }_{k = 1}^{n} {I}_{ky}^{2} ) \qquad < Equation 1 >$$

Here, G indicates the covariance matrix, g₁₁, g₁₂ and g₂₂ indicate factors making up the covariance matrix, n indicates pixels positioned in the window, Iₖₓ is a differential value in an x direction of each pixel, and I_{ky} is a differential value in a y direction of each pixel. The x direction indicates a horizontal or abscissa direction of the image frame, and the y direction indicates a vertical or ordinate direction of the image frame.

The eigen value calculating unit 314 calculates the at least one eigen value of the covariance matrix. The eigen value calculating unit 314 calculates the first and second eigen values λ₊ and λ₋ according to Equation 2 below.

$${λ}_{\pm } = ( \begin{matrix}\frac{{g}_{11} + {g}_{22} + \sqrt{Δ}}{2} … ( a ) \\ \frac{{g}_{11} + {g}_{22} + \sqrt{Δ}}{2} … ( b )\end{matrix} ) \qquad < Equation 2 >$$

where, Δ=(g₁₁−g₂₂)²+4g₁₂²

Referring to Equation 2, the eigen value calculating unit 314 outputs a greater one of the calculated (a) and (b) values as the first eigen value λ₊ and outputs a smaller one as the second eigen value λ₋.

The eigen vector calculating unit 316 calculates the at least one eigen vector of the calculated covariance matrix. The eigen vector calculating unit 316 calculates the first and second eigen vectors θ₊ and θ₋ according to Equation 3 below.

$${θ}_{\pm } = ( \begin{matrix}2 {g}_{12} & … ( c ) \\ {g}_{22} - {g}_{11} \pm \sqrt{Δ} & … ( d )\end{matrix} ) \qquad < Equation 3 >$$

In Equation 3, (c) is an x direction component of the first and second eigen vectors θ₊ and θ₋, ‘g₂₂−g₁₁+\sqrt{Δ}’ indicates a y direction component of the first eigen vector θ₊, and ‘g₂₂−g₁₁−\sqrt{Δ}’ indicates a y direction component of the second eigen vector θ₋.

After calculating the first and second eigen vectors θ₊ and θ₋ according to Equation 3, the eigen vector calculating unit 316 outputs a smaller one of the two eigen vectors to the low pass filter 330. Hereinafter, the smaller one of the first and second eigen vectors θ₊ and θ₋ is referred to as a “minimum eigen vector” θₘᵢₙ.

The weight determining unit 320 determines the feature of the window based on the calculated eigen values λ₊ and λ₋, and then determines a filtering weight based on the determined feature. In order to perform the above-mentioned operations, the weight determining unit 320 includes a feature determining unit 322 and a weight calculating unit 324.

The feature determining unit 322 compares a size of the first eigen value λ₊ to a size of the second eigen value λ₋ to determine the feature of the window. That is, the feature determining unit 322 determines whether an image pattern of the window is a corner region or an edge region other than the corner region.

Specifically, the feature determining unit 322 determines that the window is the corner region if a ratio λ₊/λ₋ of the first eigen value λ₊ to the second eigen value λ− is less than or equal to a first threshold value th1.

On the other hand, the feature determining unit 322 determines that the window is the edge region if the ratio λ₊/λ₋ of the first eigen value λ₊ to the second eigen value λ− is greater than or equal to a second threshold value th2.

Further, the feature determining unit 322 determines that the window is an intermediate region between the corner region and the edge region when the ratio λ₊/λ₋ of the first eigen value λ₊ to the second eigen value λ₋ is between the first and second threshold values th1 and th2.

The weight calculating unit 324 calculates the filtering weight (w) to filter the window based on the feature determined by the feature determining unit 322.

FIG. 5 illustrates the filtering weight (w) calculated by the weight calculating unit. Referring to FIG. 5, the weight calculating unit 324 calculates the weight (w) to be ‘0’ when the window is the corner region.

The weight calculating unit 324 calculates the weight (w) to be ‘1’ when the window is the edge region.

The weight calculating unit 324 calculates the weight (w) to vary with respect to the ratio λ₊/λ₋ of the first eigen value λ₊ to the second eigen value λ₋ when the window is the intermediate region, such that the weight (w) has a value between ‘0’ and ‘1’.

Referring back to FIG. 3, the low pass filter 330 filters the window based on the output minimum eigen vector θₘᵢₙ and the calculated filtering weight (w). That is, the low pass filter 330 confirms the edge direction of the window based on the minimum eigen vector θₘᵢₙ, and filters the window in the confirmed edge direction through the application of the filtering weight (w).

The low pass filter 330 filters an image signal at a frequency less than a predetermined frequency to remove an image signal at a frequency exceeding the predetermined frequency. This removes the jagging artifacts through removal of a high frequency component contained in an edge component of the image signal.

The low pass filter 330 includes a pixel average calculating unit 332 and a filtering unit 334.

The pixel average calculating unit 332 confirms positions of a previous pixel and a next pixel based on a position of the current pixel in the input window and the minimum eigen vector θₘᵢₙ output from the eigen vector calculating unit 316. The pixel average calculating unit 332 calculates an average value of the values of the previous and next pixels of which the respective positions are confirmed. Here, the current pixel is positioned on the current scan line Ln of the window, the positions of the previous and next pixels are determined depending on the minimum eigen vector θₘᵢₙ, and the calculated average value indicates a ‘directional pixel’.

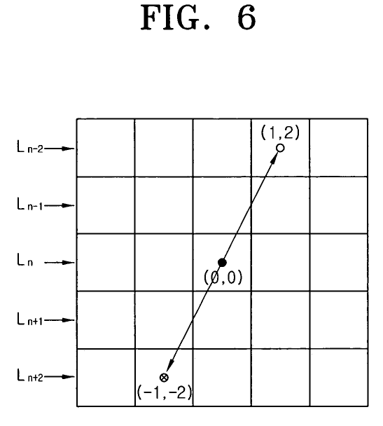

FIG. 6 illustrates a method of calculating the average value of the previous and next pixels, according to an embodiment of the present general inventive concept.

Referring to FIG. 6, when the minimum eigen vector θₘᵢₙ is (1, 2), a position (1, 2) of the previous pixel is found through movement by 1 in the x direction and 2 in the y direction from the current pixel (0, 0) (illustrated as a black colored pixel in FIG. 6). Further, a position (−1, −2) of the next pixel is found through movement by −1 in the x direction and −2 in the y direction from the current pixel (0,0). By calculating the average value of the previous pixel and the next pixel of which the respective positions are found, the directions of the previous pixel and the next pixel are confirmed (as indicated by arrows). As illustrated in FIG. 6, the previous pixel is positioned on a scan line Lₙ₋₂ preceding the previous scan line Lₙ₋₁, and the next pixel is positioned on a scan line Lₙ₊₂ succeeding the next scan line Lₙ₊₁.

The filtering unit 334 performs low pass filtering based on the calculated average value, a value of the current pixel value, and the determined filtering weight (w) to output a final pixel value (out) for the current pixel.

Specifically, the filtering unit 334 outputs the final pixel value according to Equation 4 below.
out=w×average value+(1−w)×src <Equation 4>

Equation 4 is an equation performing ‘directional low pass filtering’. In Equation 4, out indicates the final pixel value, w indicates the filtering weight, and src indicates the current pixel value.

Referring to Equation 4, the filtering unit 334 multiplies the calculated average value by the filtering weight (w) to find a first result. This filters the window by the filtering weight (w) in the edge direction for smoothing processing. The filtering unit 334 also multiplies the current pixel value by (1−w) to find a second result. The filtering unit 334 then adds the first result and the second result to output the final pixel value.

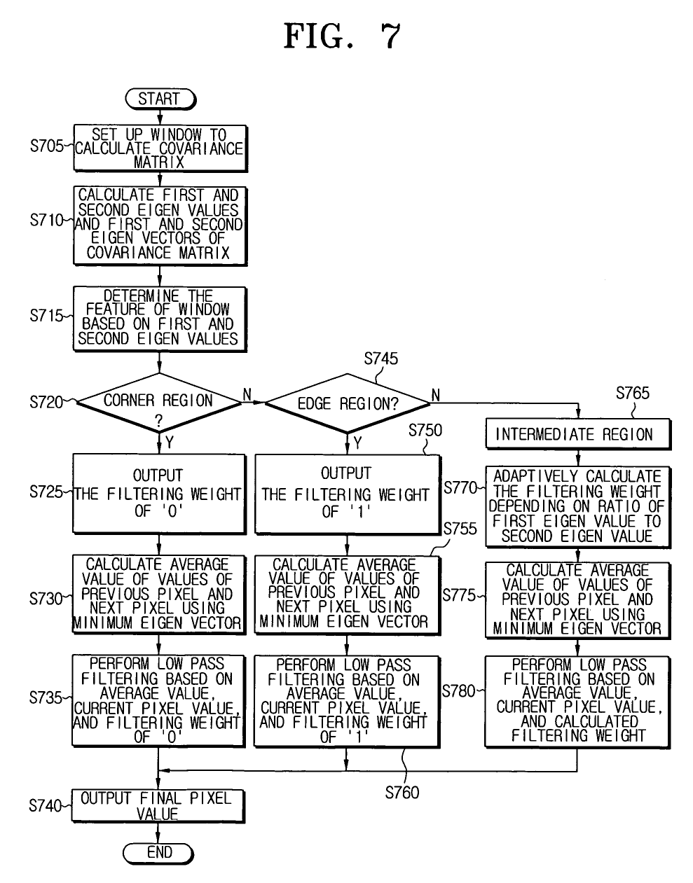

FIG. 7 is a schematic flow diagram illustrating a method of removing artifacts in the apparatus of FIG. 3, according to an embodiment of the present general inventive concept.

Referring to FIGS. 3 to 7, the matrix calculating unit 312 defines the window of the predetermined size based on the input current pixel and then applies the PCA to the defined window to calculate the covariance matrix (operation S705).

The eigen value calculating unit 314 calculates the first and second eigen values λ₊ and λ₋ of the covariance matrix, and the eigen vector calculating unit 316 calculates the first and second eigen vectors θ₊ and θ₋ of the covariance matrix (operation S710). Here, the eigen vector calculating unit 316 outputs the smaller one of the first and second eigen vectors θ₊ and θ₋ as the minimum eigen vector θₘᵢₙ.

Next, the feature determining unit 322 compares the sizes of the first and second eigen values λ₊ and λ₋ to each other to determine the feature of the window (operation S715). That is, the feature determining unit 322 determines whether the image pattern of the window is the corner region or the edge region other than the corner region.

The feature determining unit 300 determines whether the window is the corner region (operation S720). When it is determined that the window is the corner region, the weight calculating unit 324 outputs the filtering weight (w) of ‘0’ (operation S725).

The pixel average calculating unit 332 confirms the values of the previous pixel and the next pixel based on the position of the current pixel in the window and the minimum eigen vector θₘᵢₙ obtained at operation S710, and calculates the average value of the positions of the previous pixel and the next pixel (operation S730).

Next, the filtering unit 334 performs low pass filtering based on the average value of the previous and next pixels, the current pixel value, and the filtering weight (w) of ‘0’ according to Equation 4 (operation S735). Accordingly, the final pixel value (out) of the current pixel is output (operation S740). In the case that the filter weight is ‘0’, the final pixel value (out) is the same as the current pixel value.

Meanwhile, if it is determined at operation S720 that the window is not the corner region, the feature determining unit 322 determines whether the window is the edge region. When it is determined that the window is the edge region, the weight calculating unit 324 outputs the weight (w) of ‘1’ (operation S750).

The pixel average calculating unit 332 confirms the values of the previous pixel and the next pixel based on the position of the current pixel in the window and the minimum eigen vector θₘᵢₙ obtained at operation S710, and calculates the average value of the positions of the previous and next pixels (operation S755).

Next, the filtering unit 334 performs low pass filtering based on the average value of the previous and next pixels, the current pixel value, and the filtering weight (w) of ‘1’ according to Equation 4 (operation S760). Accordingly, the final pixel value (out) of the current pixel is output (operation S740). In the case that the filter weight is ‘1’, the final pixel value (out) is the same as the average value of the previous and next pixels.

On the other hand, if it is determined at operation S745 that the window is not the edge region, the feature determining unit 322 determines that the window is the intermediate region (operation S765). The weight calculating unit 324 then calculates the weight (w) by adaptively varying the weight (w) with respect to the ratio λ₊/λ₋ of the first eigen value λ₊ to the second eigen value λ₋, such that the weight (w) has a value between ‘0’ and ‘1’ (operation S770).

The pixel average calculating unit 332 confirms the positions of the previous pixel and the next pixel based on the position of the current pixel in the window and the minimum eigen vector θₘᵢₙ obtained at operation S710, and calculates the average value of the values of the previous and next pixels (operation S775).

Next, the filtering unit 334 performs low pass filtering based on the average value of the previous and next pixels, the current pixel value, and the filtering weight (w) calculated at operation S770 according to Equation 4 (operation S780). Accordingly, the final pixel value (out) of the current pixel is output (operation S740).

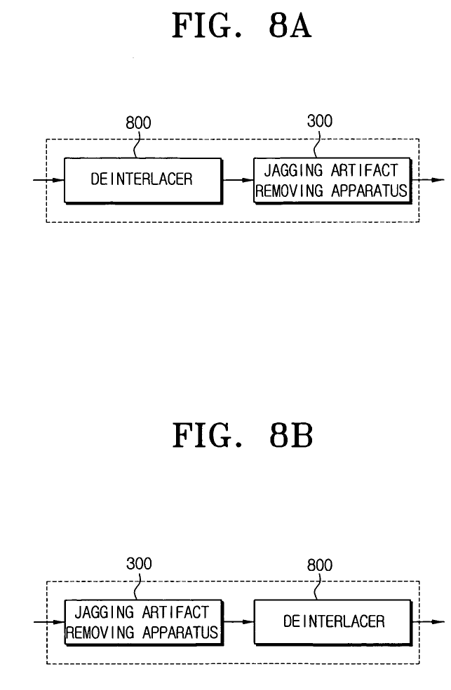

FIGS. 8A and 8B schematically illustrate an image quality processing system having the apparatus to remove jagging artifacts of FIG. 3, according to an embodiment of the present general inventive concept.

Referring to FIG. 8A, the jagging artifact removing apparatus 300 may be disposed subsequently to a deinterlacer 800 in the image quality processing system. The deinterlacer 800 converts an input image from an interlace format to a progressive scan format. The jagging artifact removing apparatus 300 performs low pass filtering on the image converted by the deinterlacer 800 to suppress or reduce staircasing (i.e., jagging artifacts) occurring due to the deinterlacing process.

Referring to FIG. 8B, the jagging artifact removing apparatus 300 may be disposed to precede the deinterlacer 800 in the image quality processing system. In this case, the jagging artifact removing apparatus 300 pre-suppresses the staircasing of the input image. The deinterlacer 800 then converts the image of which the staircasing has been suppressed from the interlace format to the progressive scan format.

Here, the jagging artifact removing apparatus 300 may be disposed preceding or subsequent to a scaler (not shown) other than the deinterlacer 800. The scaler is a device that increases and decreases a resolution of the image.

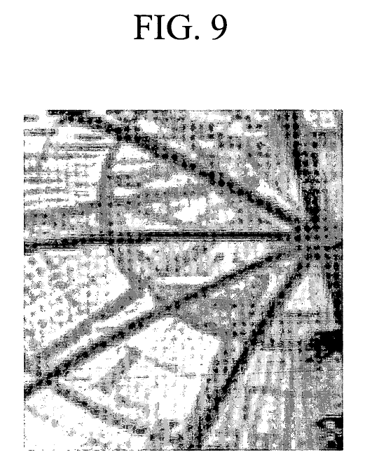

FIG. 9 illustrates an image that has no jagging artifacts.

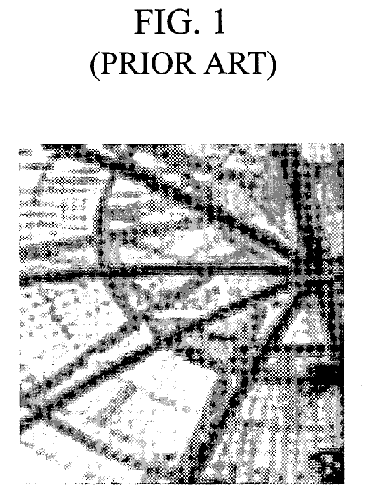

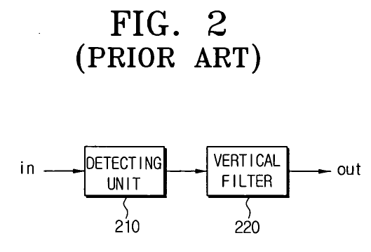

Referring to FIG. 9, application of the jagging artifact removing apparatus 300 and the method thereof according to the embodiments of the present general inventive concept to the image illustrated in FIG. 1 allows the jagging artifacts to be removed. That is, as a line of the image is viewed as a one-directional line having a smooth edge, it is possible to provide an image having an enhanced image quality to a user.

As described above, an apparatus and method to remove jagging artifacts according to the embodiments of the present general inventive concept calculate eigen values and an eigen vector through the application of PCA and uses the calculated eigen values and the eigen vector to suppress jagging artifacts. In particular, by performing directional low pass filtering using the eigen vector, it is possible to effectively suppress jagging artifacts. Further, by designing a low pass filter through consideration of the eigen values rather than threshold values between scan lines, it is possible to prevent a corner of the image from being filtered.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to remove jagging artifacts, comprising:
a calculating unit to define a window of a predetermined size based on a current pixel in an input current frame or field, and to calculate at least one eigen value and at least one eigen vector to determine a feature of the window;
a weight determining unit to determine the feature of the window based on the calculated eigen value and to determine a filtering weight based on the determined feature; and
a low pass filter to filter the window based on the calculated eigen vector and the determined filtering weight.

2. The apparatus as claimed in claim 1, wherein the at least one eigen vector comprises a first eigen vector to indicate a gradient direction of the window and a second eigen vector to indicate an edge direction thereof, and the at least one eigen value comprises a first eigen value to indicate dispersion in the gradient direction and a second eigen value to indicate dispersion in the edge direction.

3. The apparatus as claimed in claim 2, wherein the calculating unit comprises:
a matrix calculating unit to apply principal component analysis (PCA) to the window to calculate a covariance matrix;
an eigen value calculating unit to calculate the first and second eigen values based on the covariance matrix; and
an eigen vector calculating unit to calculate the first and second eigen vectors based on the covariance matrix.

4. The apparatus as claimed in claim 2, wherein the weight determining unit comprises:
a feature determining unit to compare a size of the first eigen value to a size of the second eigen value to determine the feature of the window; and
a weight calculating unit to calculate the filtering weight based on the determined feature.

5. The apparatus as claimed in claim 4, wherein the feature determining unit determines that the window is a corner region when a ratio of the first eigen value to the second eigen value is less than or equal to a first threshold value, and that the window is an edge region when the ratio is greater than or equal to a second threshold value.

6. The apparatus as claimed in claim 5, wherein the weight calculating unit calculates the weight of ‘0’ when it the window is determined to be the corner region, and the weight of ‘1’ when the window is determined to be the edge region.

7. The apparatus as claimed in claim 3, wherein the low pass filter comprises:
a pixel average calculating unit to confirm positions of a previous pixel and a next pixel in the window and an edge direction of the window based on at least one of the first and second eigen vectors output from the eigen vector calculating unit and a position of the current pixel, and to calculate an average value of the previous pixel and the next pixel; and
a filtering unit to filter the window in the confirmed edge direction using the calculated average value, a value of the current pixel, and the determined filtering weight to output a final pixel value of the current pixel.

8. The apparatus as claimed in claim 3, wherein the eigen vector calculating unit outputs a smaller one of the first and second eigen vectors as a minimum eigen vector to the low pass filter.

9. An apparatus to remove jagging artifacts from an image, comprising:
a calculating unit to calculate eigen values and eigen vectors corresponding to each pixel of an input image according to an area surrounding each pixel and to calculate a filtering weight corresponding to each pixel according to the calculated eigen values; and
a filter to filter the input image based on the calculated eigen vectors and the determined filtering weight corresponding to each pixel.

10. The apparatus as claimed in claim 9, wherein the calculating unit comprises:
a matrix calculating part to calculate a covariance matrix corresponding to each pixel according to differential values in various directions of pixels in the area surrounding each pixel and to calculate the eigen values and eigen vectors based on the calculated covariance matrix; and
a weight calculating part to compare a ratio of the calculated eigen values to first and second threshold values to calculate the filtering weight corresponding to each pixel.

11. The apparatus as claimed in claim 10, wherein the first and second threshold values are determined such that a pixel of the input image is in a corner region of the input image when the ratio of the calculated eigen values corresponding to the pixel is less than or equal to the first threshold value, a pixel of the input image is in an edge region of the input image when the ratio of the calculated eigen values corresponding to the pixel is greater than or equal to the second threshold value, and a pixel of the input image is in an intermediate region of the input image when the ratio of the calculated eigen values is between the first and second threshold values.

12. The apparatus as claimed in claim 10, wherein the weight calculating part determines the filtering weight to be zero when the ratio of the calculated eigen values is less than or equal to the first threshold value, to be one when the ratio of the calculated eigen values is greater than or equal to the second threshold value, and to be between zero and one when the ratio of the calculated eigen values are between the first and second threshold values.

13. The apparatus as claimed in claim 9, wherein the filter comprises:
a pixel average calculating part to determine positions of previous and next pixels corresponding to each pixel according to a position of each pixel and a minimum one of the calculated eigen vectors corresponding to each pixel and to calculate an average of the values of the previous and next pixels corresponding to each pixel; and
a filtering unit to adjust the value of each pixel according to the calculated average of the values of the previous and next pixels and the determined filtering weight corresponding to each pixel.

14. An apparatus to remove jagging artifacts from an image, comprising:
a calculating unit to define a region of a predetermined size surrounding each pixel of an image, to determine a feature of each defined region, and to calculate a filtering weight corresponding to each pixel based on the determined feature of the surrounding region; and
a filter to calculate average value of values of a previous and next pixel corresponding to each pixel and to filter the image based on the calculated average value and filtering weight corresponding to each pixel.

15. A method of removing jagging artifacts, comprising:
defining a window of a predetermined size based on a current pixel in an input current frame or field;
calculating at least one eigen value and at least one eigen vector to determine a feature of the window;
determining the feature of the window based on the calculated eigen value and determining a filtering weight based on the determined feature; and
filtering the window based on the calculated eigen vector and the determined filtering weight.

16. The method as claimed in claim 15, wherein the at least one eigen vector comprises a first eigen vector to indicate a gradient direction of the window and a second eigen vector to indicate an edge direction thereof, and the at least one eigen value comprises a first eigen value to indicate dispersion in the gradient direction and a second eigen value to indicate dispersion in the edge direction.

17. The method as claimed in claim 16, wherein the calculating of the at least one eigen value and the at least one eigen vector comprises:
applying principal component analysis (PCA) to the window to calculate a covariance matrix;
calculating the first and second eigen values based on the covariance matrix; and
calculating the first and second eigen vectors based on the covariance matrix.

18. The method as claimed in claim 16, wherein the determining of the feature of the window and determining the filtering weight based on the determined feature comprises:
comparing a size of the first eigen value to a size of the second eigen value to determine the feature of the window; and
calculating the filtering weight based on the determined feature.

19. The method as claimed in claim 18, wherein the comparing of the size of the first eigen value to the size of the second eigen value to determine the feature of the window comprises:
determining that the window is a corner region when a ratio of the first eigen value to the second eigen value is less than or equal to a first threshold value; and
determining that the window is an edge region when the ratio is greater than or equal to a second threshold value.

20. The method as claimed in claim 19, wherein the calculating of the filtering weight comprises:
determining the weight to be ‘0’ when the window is determined to be the corner region; and
determining the weight to be ‘1’ when the window is determined to be the edge region.

21. The method as claimed in claim 17, wherein the filtering of the window comprises:
confirming positions of a previous pixel and a next pixel in the window and an edge direction of the window based on at least one of the first and second calculated eigen vectors and a position of the current pixel, and calculating an average value of the previous pixel and the next pixel; and
filtering the window in the confirmed edge direction using the calculated average value, a value of the current pixel, and the determined filtering weight to output a final pixel value of the current pixel.

22. The method as claimed in claim 17, wherein the calculating of the first and second eigen vectors comprises:
outputting a smaller one of the first and second eigen vectors as a minimum eigen vector.

23. A method of removing jagging artifacts from an image, the method comprising:
calculating eigen values and eigen vectors corresponding to each pixel of an image;
determining a filtering weight corresponding to each pixel according to the calculated eigen values; and
filtering each pixel according to the determined filtering weight and the calculated eigen vectors.

24. The method as claimed in claim 23, wherein the calculating of the eigen values and the eigen vectors comprises:
defining a window of a predetermined size around each pixel;
calculating first and second eigen vectors corresponding to a gradient direction and an edge direction of the window, respectively; and
calculating first and second eigen values corresponding to dispersion in the gradient direction and dispersion in the edge direction, respectively.

25. The method as claimed in claim 23, wherein the calculating of the eigen values and the eigen vectors comprises:
calculating a covariance matrix corresponding to each pixel according to differential values in various directions of pixels in a predetermined area surrounding each pixel; and
calculating the eigen values and the eigen vectors based on the covariance matrix.

26. The method as claimed in claim 23, wherein the determining of the filtering weight comprises:
comparing a ratio of the calculated eigen values to first and second threshold values; and
determining the filtering weight according to a result of the comparison.

27. The method as claimed in claim 26, wherein the determining the filtering weight according to the result of the comparison comprises:
determining the filtering weight to be zero when the ratio is less than or equal to the first threshold value;
determining the filtering weight to be one when the ratio is greater than or equal to the second threshold value; and
determining the filtering weight to be between zero and one when the ratio is between the first and second threshold values.

28. The method as claimed in claim 27, wherein the filtering of each pixel comprises:
outputting a current value of a pixel when the filtering weight corresponding to the pixel is zero; and
outputting an average value of a next pixel and a previous pixel corresponding to a pixel when the filtering weight corresponding to the pixel is one.

29. The method as claimed in claim 23, wherein the filtering of each pixel comprises:
calculating an average value of previous and next pixels corresponding to each pixel according to a position of each pixel and a minimum one of the calculated eigen vectors corresponding to each pixel; and
determining an output value of each pixel according to a value of each pixel, the calculated average value of the previous and next pixels corresponding to each pixel, and the filtering weight corresponding to each pixel.

30. A method of removing jagging artifacts from an image, comprising:
defining a region of a predetermined size surrounding each pixel of an image;
determining a feature of each region;
calculating a filtering weight corresponding to each pixel based on the determine feature of the surrounding region; and
filtering the image based on the calculated filtering weight and an average of values of previous and next pixels corresponding to each pixel.
